(19) United States
(12) Patent Application Publication
(10) Pub. No.: US 2012/0099087 A1
(43) Pub. Date: Apr. 26, 2012

(54) PROJECTION DISPLAY DEVICE

(75) Inventors: Kenta SAKUMA, Osaka (JP); Hiromitsu GISHI, Osaka (JP); Taichi YOSHIMURA, Osaka (JP); Atsushi KUBO, Osaka (JP); Hiroshi HAYASHI, Osaka (JP); Kouji SHIRAITO, Amagasaki-city (JP)

(73) Assignee: SANYO ELECTRIC CO., LTD., Osaka (JP)

(21) Appl. No.: 13/281,057

(22) Filed: Oct. 25, 2011

(30) Foreign Application Priority Data
Oct. 25, 2010 (JP) 2010-238717

(51) Int. Cl. G03B 21/14

(52) U.S. Cl. 353/119

(57) ABSTRACT

A projection display device includes an opening formed in a main body cabinet; a part to be attached in the main body cabinet through the opening; a cover which covers the opening; a detector which detects closure of the cover; and a first contact part and a second contact part which contact each other when the cover is being closed, thereby to prevent the cover from being closed up to a position where the closure is detected by the detector. When the part to be attached is not attached, the first contact part is positioned on a line contacting the second contact part at closure of the cover and is capable of evacuating to a position out of the line. The projection display device further includes an evacuation part to evacuate the first contact part to the position out of the line when the part to be attached is attached.

This application claims priority under 35 U.S.C. Section 119 of Japanese Patent Application No. 2010-238717 filed Oct. 25, 2010, entitled “PROJECTION DISPLAY DEVICE”. The disclosure of the above application is incorporated herein by reference.

### BACKGROUND OF THE INVENTION

1. Field of the Invention

The present invention relates to a projection display device which modulates light from a light source and projects the modulated light onto a projection plane.

2. Disclosure of Related Art

Conventionally, a projection display device such as liquid crystal projectors (hereinafter, referred to as “projector”) modulates light from a light source by an imager, and projects the modulated light onto a projection plane by a projection lens. The light source and the imager in the projector may deteriorate with time. When the light source and the imager come to operate inappropriately due to such deterioration, the light source and the imager need to be replaced with new ones.

In addition, such a projector generates heat at the light source, the imager, and the like. Accordingly, the projector is equipped with a cooling unit to cool down these heat generating parts by air taken in from the outside. A filter for removing dust and the like out of outside air is arranged on an upstream side of the cooling unit in the projector. When the filter gets clogged, the filter needs to be cleaned or replaced with a new one.

The parts to be attached such as the light source, the imager, and the filter, can be housed in a main body cabinet through an opening formed in the main body cabinet. In this case, the opening can be opened and closed by a cover.

In the foregoing configuration, the projector needs to be operated in a state where the parts to be attached are attached in the main body cabinet and the cover is fully closed. Accordingly, detection switches such as micro-switches may be provided to detect whether the parts to be attached are attached in the main body cabinet and whether the cover is fully closed. In this case, generally, two respective detection switches are provided in correspondence with the parts to be attached and the cover.

A cover open/close detection unit may be configured to detect opening and closing of two covers by one detection switch. For example, the cover open/close detection unit is provided with a changeover member to change the open/close detection switch. In addition, one of the covers is provided with a first actuation member to displace the changeover member when the cover is closed. The open/close detection switch is not changed by displacement of the changeover member only by the first actuation member. The other cover is provided with a second actuation member to increase a pressing force of the first actuation member when the cover is closed. When both of the covers are closed, the second actuation member increases a pressing force of the first actuation member to displace the changeover member significantly, thereby changing the open/close detection switch.

Provision of two detection switches as stated above, leads to relatively large cost increase. Therefore, the cover open/close detection unit is desirably configured to use only one detection switch as described above.

### SUMMARY OF THE INVENTION

A projection display device according to a main aspect of the present invention includes an opening formed in a main body cabinet; a part to be attached in the main body cabinet through the opening; a cover which covers the opening; a detector which detects closure of the cover; and a first contact part and a second contact part which contact each other when the cover is being closed, thereby to prevent the cover from being closed up to a position where the closure is detected by the detector. In this arrangement, the first contact part is configured to be positioned on a line contacting the second contact part at closure of the cover and to be capable of evacuating to a position out of the line when the part to be attached is not attached in the main body cabinet. In addition, the projection display device further includes an evacuation part to evacuate the first contact part to the position out of the line when the part to be attached is attached in the main body cabinet.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams (perspective views) showing an external construction of a projector embodying the invention.

FIG. 2 is a diagram (bottom view) showing an external construction of the projector as the embodiment.

FIG. 3 is a diagram showing an internal structure of the projector as the embodiment.

FIG. 4 is a diagram schematically showing an arrangement of a projection optical unit in the embodiment.

FIGS. 5A and 5B are diagrams showing a configuration of a lamp unit and a fan unit in the embodiment;

FIGS. 6A and 6B are diagrams showing a configuration of a filter unit in the embodiment;

FIGS. 7A and 7B are diagrams showing a structure of attachment of a lamp cover to a cover attachment part in the embodiment;

FIGS. 8A to 8C are diagrams showing a structure of attachment of the lamp cover to the cover attachment part in the embodiment;

FIGS. 9A and 9B are diagrams showing a configuration of the lamp cover in the embodiment;

FIGS. 10A to 10D are diagrams showing that the lamp cover is closed with the filter unit not housed in a filter housing part and that the lamp cover is closed after the filter unit is housed in the filter housing part in the embodiment;

FIGS. 11A and 11B are diagrams showing a configuration of a filter unit in a modification example;

FIGS. 12A and 12B are diagrams showing a structure of attachment of a lamp cover to a cover attachment part in the modification example;

FIGS. 13A and 13B are diagrams showing a configuration of the lamp cover in the modification cover; and

FIGS. 14A to 14D are diagrams showing that the lamp cover is closed with the filter unit not housed in the filter housing part and that the lamp cover is closed after the filter unit is housed in the filter housing part in the modification example.

The drawings are provided only for describing the present invention, and do not limit the scope of the present invention.

### Description of Preferred Embodiments

A projector in an embodiment of the present invention will be described below with reference to the drawings.

In this embodiment, a filter opening 103 corresponds to an “opening” recited in the claims; a guide groove 104 corresponds to a “groove part” recited in the claims; a detection switch 107 corresponds to a “detector” recited in the claims; a projection part 111 and a contact part 520a correspond to a “first contact part” recited in the claims; a projection part 120 corresponds to a “second contact part” recited in the claims; a lamp cover 5 corresponds to a “cover” recited in the claims; an engagement part 506 corresponds to the “second contact part” and a “guide part” recited in the claims; a filter unit 700 corresponds to a “part to be attached” recited in the claims; a pressing piece 716 corresponds to a “pressing part” and an “evacuation part” recited in the claims; and a guide surface 717a corresponds to the “evacuation part” recited in the claims. However, the foregoing correspondences in description between the claims and this embodiment are mere examples, and are not intended to limit the claims to this embodiment.

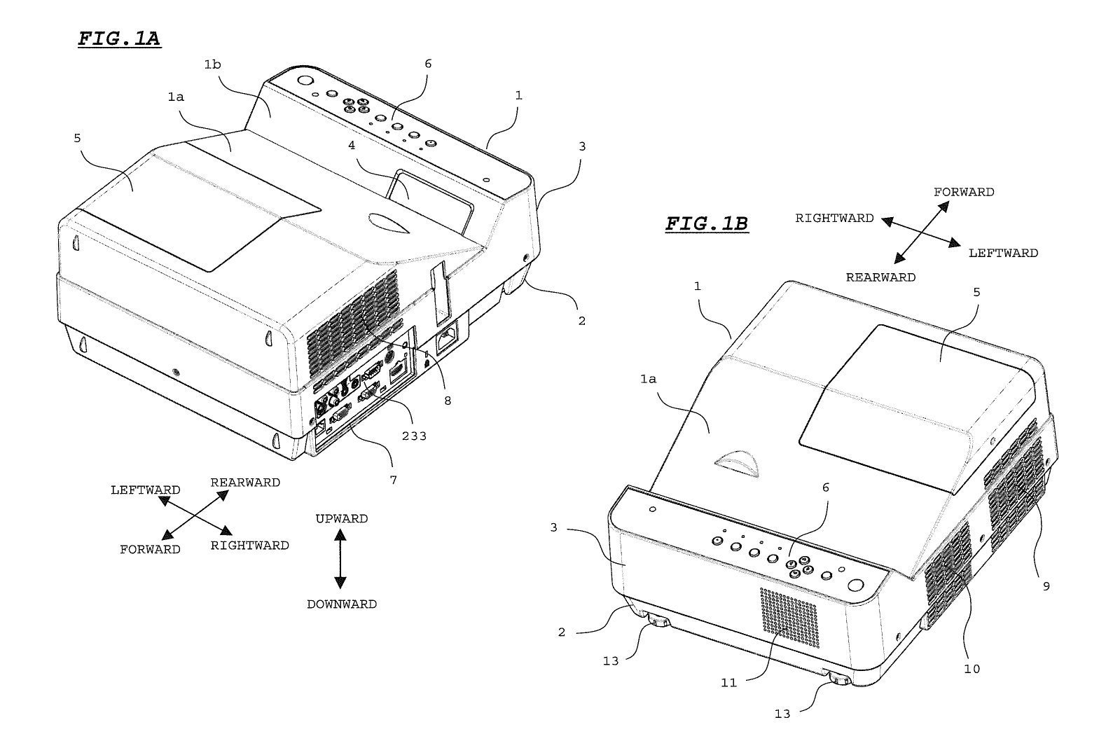

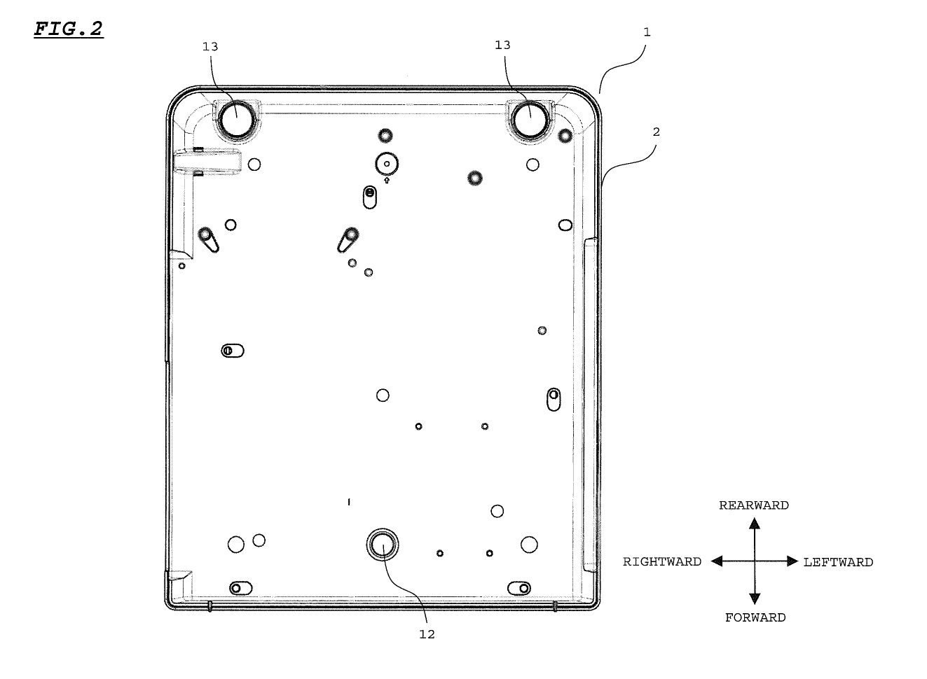

FIGS. 1A, 1B and FIG. 2 are diagrams showing an external construction of a projector embodying the invention. FIG. 1A is a perspective view of the projector when viewed from a front side, and FIG. 1B is a perspective view of the projector when viewed from a rear side. FIG. 2 is a bottom view of the projector. To simplify the description, arrows respectively indicating forward, rearward, leftward, and rightward directions, and arrows each indicating upward and downward directions are depicted in FIGS. 1A, 1B and FIG. 2. Hereinafter, the arrows indicating forward, rearward, leftward, and rightward directions are depicted in the same manner as above in the other drawings, as necessary.

The projector of the embodiment is a so-called short focus projector. Referring to FIGS. 1A and 1B, the projector is provided with a main body cabinet 1 having a substantially rectangular parallelepiped shape. The main body cabinet 1 is constituted of a lower cabinet 2, and an upper cabinet 3 which is placed on the lower cabinet 2 from above.

A top surface of the main body cabinet 1 is formed with a first slope 1a inclined downward and rearward, and a second slope 1b continuing from the first slope 1a and inclined upward and rearward. The second slope 1b faces obliquely upward and forward, and a projection port 4 is formed in the second slope 1b. Image light emitted obliquely upward and forward through the projection port 4 is enlarged and projected onto a screen disposed in front of the projector.

Further, the top surface of the main body cabinet 1 is formed with a lamp cover 5. The top surface of the main body cabinet 1 is formed with a lamp opening for use in exchanging a lamp unit, and a filter opening for use in exchanging a filter disposed in a fan unit for cooling the lamp unit. The lamp cover 5 is a cover for covering the lamp opening and the filter opening. Further, the top surface of the main body cabinet 1 is provided with an operation portion 6 constituted of a plurality of operation keys.

A terminal port portion 7 is formed in a right surface of the main body cabinet 1. A terminal panel 233 having various terminals such as AV terminals is attached to the terminal port portion 7. The terminal panel 233 constitutes a part of a control circuit unit to be described later. Audio Visual (AV) signals such as an image signal and an audio signal are inputted and outputted to and from the projector through the AV terminals. Further, an air inlet 8 is formed in the right surface of the main body cabinet 1 at a position above the terminal port portion 7. The air inlet 8 is constituted of multitudes of slit holes, and external air is drawn into the main body cabinet 1 through the air inlet 8.

A first air outlet 9 is formed in a front portion on a left surface of the main body cabinet 1, and a second air outlet 10 is formed in a middle portion on the left surface of the main body cabinet 1. Each of the first and second air outlets 9, 10 is constituted of multitudes of slit holes, and air inside the main body cabinet 1 is discharged to the outside of the projector through the first and second air outlets 9, 10. Further, a sound output port 11 is formed in a rear surface of the main body cabinet 1. Sounds in accordance with images are outputted through the sound output port 11 at the time of image projection.

Referring to FIG. 2, a fixed leg 12 is disposed in the middle of a front portion on a bottom surface of the main body cabinet 1, and two adjustable legs 13 are disposed at a rear end thereof. By expanding or contracting the two adjustable legs 13 up and down, it is possible to adjust the inclination of the main body cabinet 1 in forward/rearward directions and leftward/rightward directions. Thus, it is possible to adjust the upward/downward position and the leftward/rightward inclination of an image projected on a screen.

The projector of the embodiment may be installed in a suspended state from a ceiling with the main body cabinet 1 being upside down, other than an installation manner that the bottom surface of the main body cabinet 1 is placed on an installation plane such as a desk surface or a floor surface. Further, a front surface of the main body cabinet 1 is a flat surface without the terminal panel 233 and the air inlet 8. Accordingly, it is possible to install the projector of the embodiment in such a manner that the front surface of the main body cabinet 1 is placed on an installation plane. In this case, an image is projected on the installation plane itself.

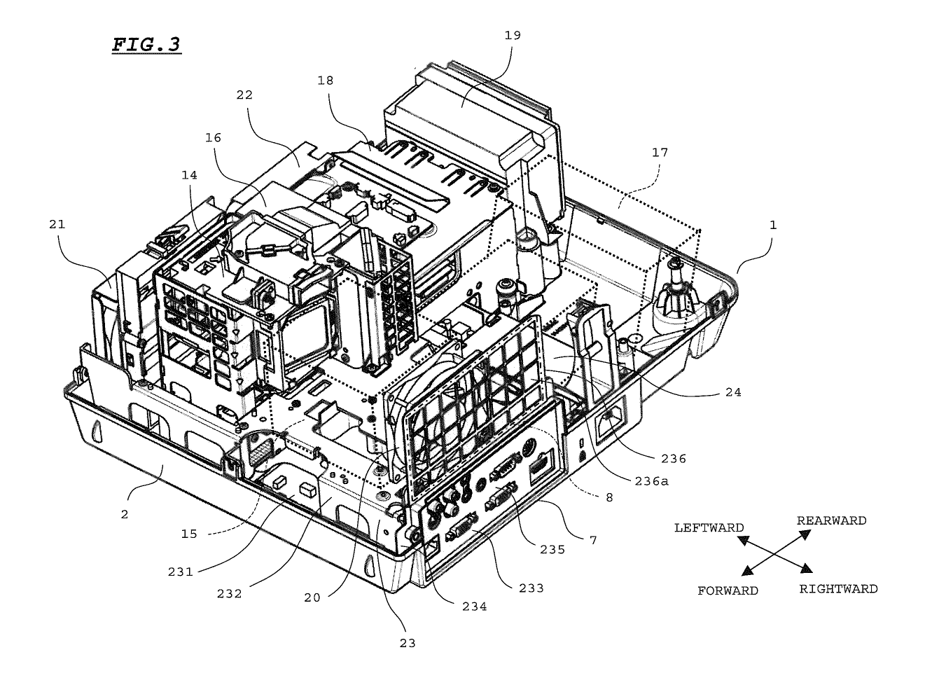

FIG. 3 is a diagram showing an internal structure of the projector. FIG. 3 is a perspective view showing a state that the upper cabinet 3 is detached, when viewed from a front side. To simplify the description, in FIG. 3, an imager unit 15 and a projection optical unit 17 are indicated by the dotted lines. Further, the position of the air inlet 8 is indicated by the one-dotted chain line.

Referring to FIG. 3, a lamp unit 14, and the imager unit 15 for modulating light from the lamp unit 14 to generate image light are disposed on a front portion of the lower cabinet 2.

The lamp unit 14 is constituted of a light source lamp, and a lamp holder for holding the light source lamp; and is configured so as to be detachably attached from above. A fan unit 16 is disposed behind the lamp unit 14. The fan unit 16 supplies external air (cooling air) drawn through the air inlet 8 to the light source lamp to cool the light source lamp. The lamp holder is formed with an air duct for guiding the cooling air from the fan unit 16 to the light source lamp.

The imager unit 15 includes a color wheel and a Digital Micromiror Device (DMD). The color wheel separates white light from the light source lamp into light of respective colors such as red, green, blue in a time-sharing manner. The DMD modulates the light of the respective colors emitted from the color wheel based on an image signal.

The imager unit 15 may be configured to include a light-guiding optical system that separates white light from the light source lamp into lights of red, green, and blue, three liquid crystal panels that modulate the separated color lights, and a dichroic prism that combines the lights separated by the liquid crystal panels. In this case, the three liquid crystal panels and the dichroic prism are integrated into a prism unit.

The projection optical unit 17 is disposed at a rear position of the imager unit 15. The projection optical unit 17 enlarges image light generated by the imager unit 15, and projects the enlarged image light onto a projection plane such as a screen.

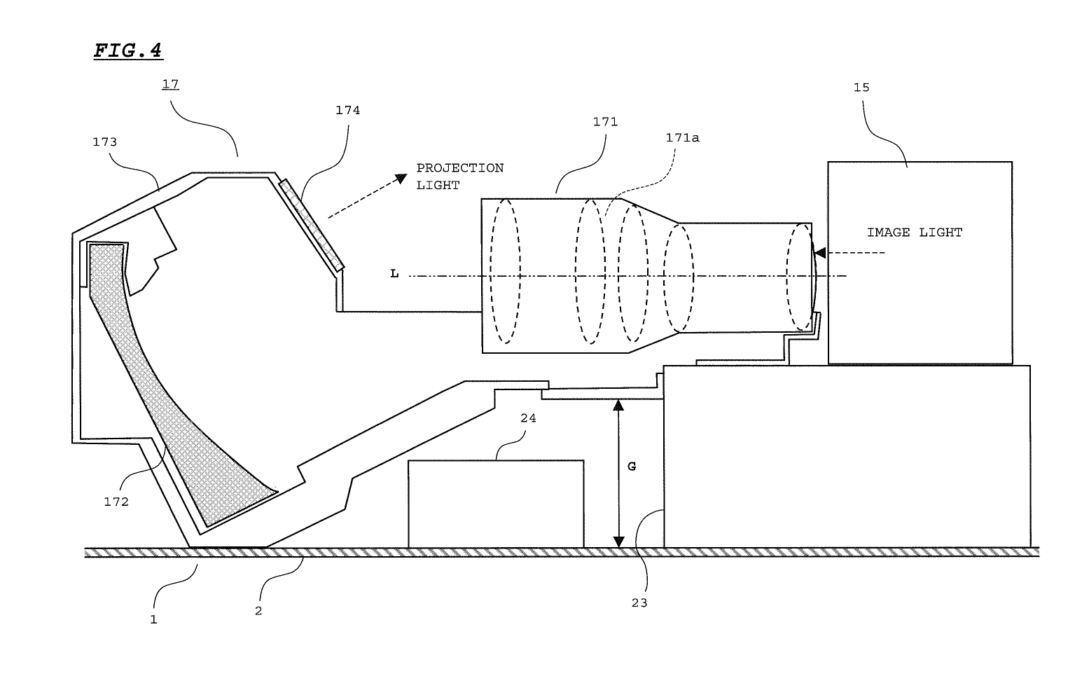

FIG. 4 is a diagram schematically showing an arrangement of the projection optical unit 17. In FIG. 4, the imager unit 15, a control circuit unit 23, and a noise filter unit 24 are schematically shown, in addition to the projection optical unit 17.

The projection optical unit 17 is constituted of a projection lens unit 171, a reflection mirror 172, and a housing 173 for housing the projection lens unit 171 and the reflection mirror 172. The projection lens unit 171 has a plurality of lenses 171a. The reflection mirror 172 is a curved mirror or a free curved mirror.

As shown in FIG. 4, image light emitted from the imager unit 15 is entered into the projection lens unit 171 at a position shifted from the optical axis L of the projection lens unit 171 in a direction toward the top surface of the main body cabinet 1. The entered image light is provided with a lens action by the projection lens unit 171, and is entered into the reflection mirror 172. Thereafter, the projection angle of the image light is expanded by the reflection mirror 172, and the image light is projected onto a projection plane (screen) via a light ray passage window 174.

As described above, image light is entered into the projection lens unit 171 at a position shifted from the optical axis L of the projection lens unit 171 in a direction toward the top surface of the main body cabinet 1. In view of this, the reflection mirror 172 is disposed at a position shifted from the optical axis L of the projection lens unit 171 toward the bottom surface of the main body cabinet 1. Here, the reflection mirror 172 has a reflection surface larger than the lens surface of each lens 171a constituting the projection lens unit 171. Accordingly, the shift amount of the reflection mirror 172 with respect to the optical axis L of the projection lens unit 171 is relatively large. Consequently, there is defined a relatively large space G between a lower surface of the projection lens unit 171 and the bottom surface of the main body cabinet 1 (lower cabinet 2). The space G is defined from the position where the projection lens unit 171 is disposed to the position where the imager unit 15 is disposed.

Referring back to FIG. 3, a power source unit 18 is disposed behind the fan unit 16. The power source unit 18 is provided with a power source circuit to supply electric power to each electric component of the projector. A speaker 19 is disposed behind the power source unit 18. Sounds outputted through the speaker 19 are released to the outside through the sound output port 11.

A DMD cooling fan 20 is disposed on the right of the imager 15. The DMD cooling fan 20 supplies external air drawn through the air inlet 8 to the imager unit 15 so as to cool the DMD. The DMD is sealably disposed in the imager unit 15, so that the DMD is kept from being directly contacted with the supplied external air.

A lamp exhaust fan 21 is disposed on a left side of the lamp unit 14. The lamp exhaust fan 21 takes in cooling air having cooled down the light source lamp, and then discharges the same to the outside through the first air outlet 9.

A power source exhaust fan 22 is disposed on a left side of the power source unit 18. The power source exhaust fan 22 takes in heated air from the power source unit 18, and discharges the same to the outside through the second air outlet 10. When the air flows from the power source unit 18 into the power source exhaust fan 22, new outside air is taken in from the air inlet 8 and is supplied to the power source unit 18.

As shown in FIG. 3 and FIG. 4, in the projector of the embodiment, the control circuit unit 23 and the noise filter unit 24 are disposed in the space G defined below the projection lens unit 171 and the imager unit 15.

The noise filter unit 24 is provided with a circuit board mounted with a noise filter and a fuse thereon, and supplies electric power inputted from a commercial AC power source to the power source unit 18 after noise removal.

The control circuit unit 23 includes a control circuit board 231, a holder 232 for holding the control circuit board 231, the terminal panel 233, and a fixing board 234 for fixing the terminal panel 233.

A control circuit for controlling various driving components such as a light source lamp and a DMD is mounted on the control circuit board 231. Further, various terminals 235 are mounted on the control circuit board 231.

The terminal panel 233 is formed with various openings of the shapes in accordance with the shapes of the terminals 235. The terminals 235 are exposed to the outside through the openings. Although not illustrated, the fixing board 234 is formed with openings through which the terminals 235 pass, as well as the terminal panel 233.

The fixing board 234 is made of a metal material, and a shielding portion 236 is formed on an upper portion thereof. The shielding portion 236 is formed with multitudes of openings 236a, and a metal mesh (not shown) is attached to each of the openings 236a. The shielding portion 236 is disposed on the inside of the air inlet 8 to block electromagnetic wave from leaking to the outside through the air inlet 8. External air drawn through the air inlet 8 is supplied to the inside of the main body cabinet 1 through the openings 236a.

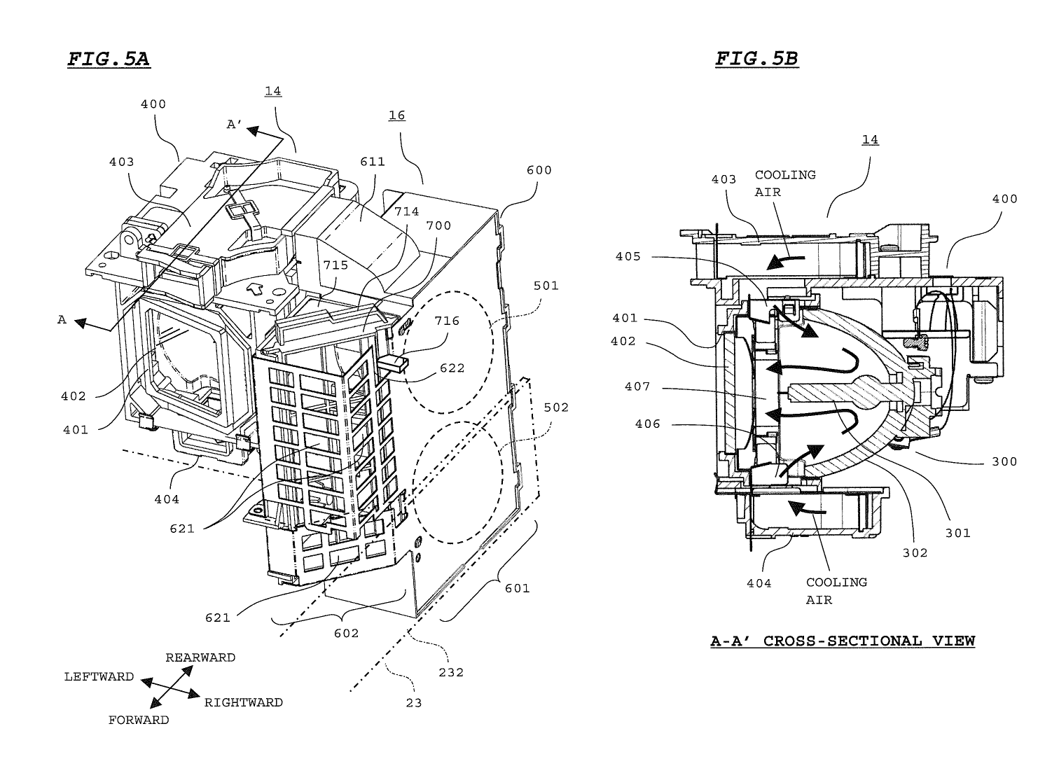

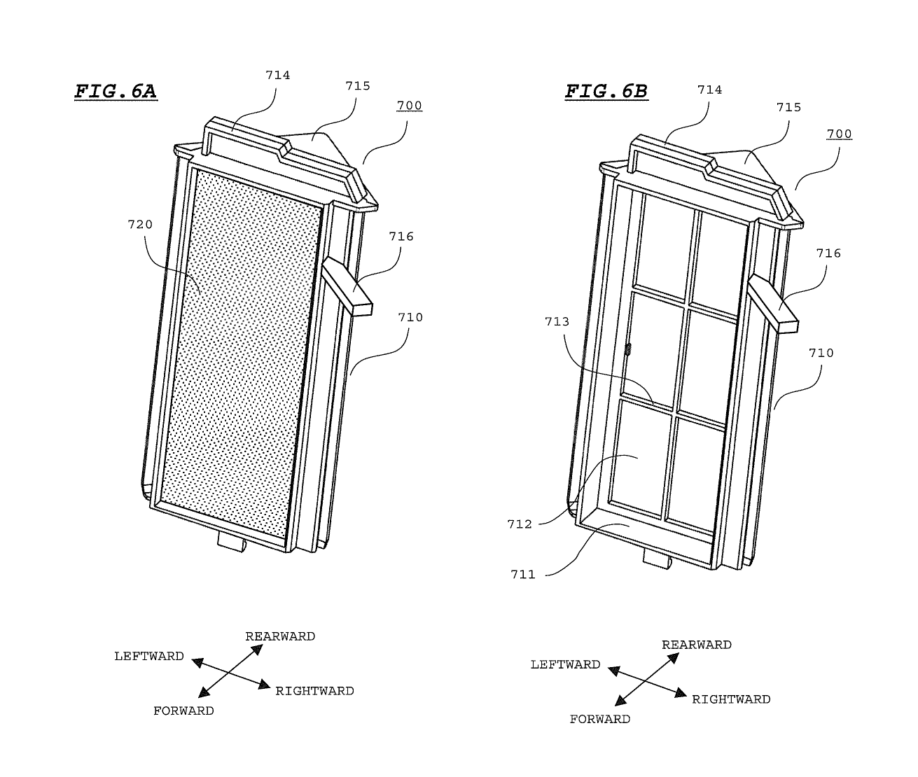

Next, referring to FIGS. 5A to 6B, a configuration of the lamp unit 14 and the fan unit 16 will be described below in detail.

FIGS. 5A and 5B are diagrams showing a configuration of the lamp unit 14 and the fan unit 16. FIG. 5A is a perpendicular view of the lamp unit 14 and the fan unit 16 as seen from the front. FIG. 5B is a cross-sectional view of FIG. 5A taken along line A-A′. In FIGS. 5A and 5B, a filter 720 constituting the filter unit 700 is omitted for the sake of convenience.

Referring to FIGS. 5A and 5B, the lamp unit 14 is constituted of a light source lamp 300 and a lamp holder 400 for holding the light source lamp 300.

As shown in FIG. 5B, the light source lamp 300 includes a luminous tube 301 and a reflector 302. The luminous tube 301 uses a metal halide lamp. Alternatively, the luminous tube 301 may use an ultrahigh pressure mercury lamp, a xenon lamp, or the like. The reflector 302 has a parabolic inner surface to reflect white light emitted from the luminous tube 301 so as to travel forward.

The lamp holder 400 has on a front surface thereof an output window 401 through which light from the light source lamp 300 is output. The output window 401 has a heat-resistive concave lens 402 fitted. The lamp holder 400 has an open rear surface to which the light source lamp 300 is attached from behind.

The lamp holder 400 has an upper duct 403 and a lower duct 404 on upper and lower parts thereof, respectively. In addition, as shown in FIG. 5B, the lamp holder 400 has an upper blowing port 405 leading to the upper duct 403 and a lower blowing port 406 leading to the lower duct 404, which are oriented to an interior of the reflector 302. Further, the lamp holder 400 has exhaust openings 407 on right and left sides of a central part thereof. Out of the right and left exhaust openings 407, FIG. 5B shows only the left exhaust opening 407.

Metal net parts not shown are arranged at an interior of the upper duct 403, an interior of the lower duct 404, and the right and left exhaust openings 407. If the luminous tube 301 is broken, these metal net parts prevent broken pieces from coming out.

The fan unit 16 includes two lamp cooling fans 501 and 502, a fan casing 600 in which the lamp cooling fans 501 and 502 are housed, and the filter unit 700 attached to the fan casing 600. The fan unit 16 is fixed to the holder 232 of the control circuit unit 23.

The lamp cooling fans 501 and 502 are centrifugal fans, for example. The fan casing 600 is constituted of a fan housing part 601 and a filter housing part 602 arranged in front of the fan housing part 601. The fan housing part 601 houses the lamp cooling fans 501 and 502 stacked vertically in two stages. The filter housing part 602 houses the filter unit 700.

The fan housing part 601 has a substantially rectangular parallelepiped shape. Meanwhile, the filter housing part 602 has a hollow prismatic shape with a substantially rectangular shape in cross section, with a top surface thereof formed into an opening and a bottom surface. However, a lower end of the filter housing part 602 is formed into an inclined surface at portions corresponding to a right surface and a front surface thereof, and is configured into a hollow prismatic shape approximate to a triangular shape in cross section.

The fan housing part 601 has a first duct 611 on an upper portion thereof. The first duct 611 has an entrance connected to a discharge opening of the lamp cooling fan 501. The first duct 611 has an exist leading to the upper duct 403 of the lamp holder 400. In addition, the fan housing part 601 has a second duct (not shown) on a central part thereof. The second duct has an entrance connected to a discharge opening of the lamp cooling fan 502. The second duct has an exist leading to the lower duct 404 of the lamp holder 400.

FIGS. 6A and 6B are diagrams showing a configuration of the filter unit 700. FIG. 6A is a perpendicular view of the filter unit 700 with the filter 720 attached. FIG. 6B is a perpendicular view of the filter unit 700 with the filter 720 not yet attached.

Referring to FIGS. 6A and 6B, the filter unit 700 is constituted of a filter holder 710 and the filter 720 attached to the filter holder 710.

The filter holder 710 includes a housing concave part 711 in which the filter 720 is housed. The housing concave part 711 has a vent hole 712 in a bottom surface thereof. The vent hole 712 is formed with a lattice 713.

The filter holder 710 has a handle 714 on an upper end portion thereof. The filter holder 710 has a substantially triangular cover portion 715 behind the handle 714. The filter holder 710 has a pressing piece 716 at an upper left end portion thereof.

The filter 720 is a rectangular urethane filter. The filter 720 is fixed to the housing concave part 711 with an adhesive, for example. In addition, the filter 720 may be a filter made of a material other than urethane, for example, a filter made of a nonwoven cloth.

Returning to FIGS. 5A and 5B, the filter housing part 602 has an air inlet 621 including a plurality of openings in a surface of an air intake side with respect to the filter unit 700. In addition, the filter housing part 602 has a notch part 622 to avoid the pressing piece 716 projecting from the filter unit 700 when the filter unit 700 is attached.

During operation of the projector, the lamp cooling fans 501 and 502 are driven. In addition, the DMD cooling fan 20, the lamp exhaust fan 21, and the power source exhaust fan 22 are driven. Accordingly, outside air is taken into the main body cabinet 1 through the air inlet 8.

The outside air taken into the main body cabinet 1 flows as cooling air into the filter housing part 602 through the air inlet 621. The cooling air flowing into the filter housing part 602 passes through the filter 720. At that time, dirt and dust contained in the cooling air cannot pass through the filter 720 but adhere to the filter 720. The cooling air having been cleared of dust and the like by the filter 720, flows into the fan housing part 601 and is taken into the lamp cooling fans 501 and 502.

As described above, the upper opening of the filter housing part 602 on an exhaust side with respect to the filter unit 700 is covered with the cover part 715 by attaching the filter unit 700 (refer to FIG. 5A). Accordingly, it is possible to prevent the cooling air from being taken into the fan housing part 601 from flow paths other than the flow path passing through the filter unit 700, and supply the clean cooling air to the lamp unit 14.

The cooling air blowing from the lamp cooling fans 501 and 502 flows into the upper duct 403 and the lower duct 404 of the lamp holder 400 through the first duct 611 and the second duct, respectively.

FIG. 5B shows by arrows a flow of cooling air in the lamp unit 14. The cooling air having flown into the upper duct 403 passes through the duct and reaches the upper blowing port 405, and then blows from the upper blowing port 405 into the interior of the reflector 302 in the light source lamp 300. In addition, the cooling air having flown into the lower duct 404 passes through the duct and reaches the lower blowing port 406, and then blows from the lower blowing port 406 into the interior of the reflector 302. The cooling air flowing into the reflector 302 from the upper and lower sides cools down the interior of the reflector 302. After that, the cooling air in the reflector 302 is discharged from the exhaust opening 407 to an exterior of the lamp unit 14.

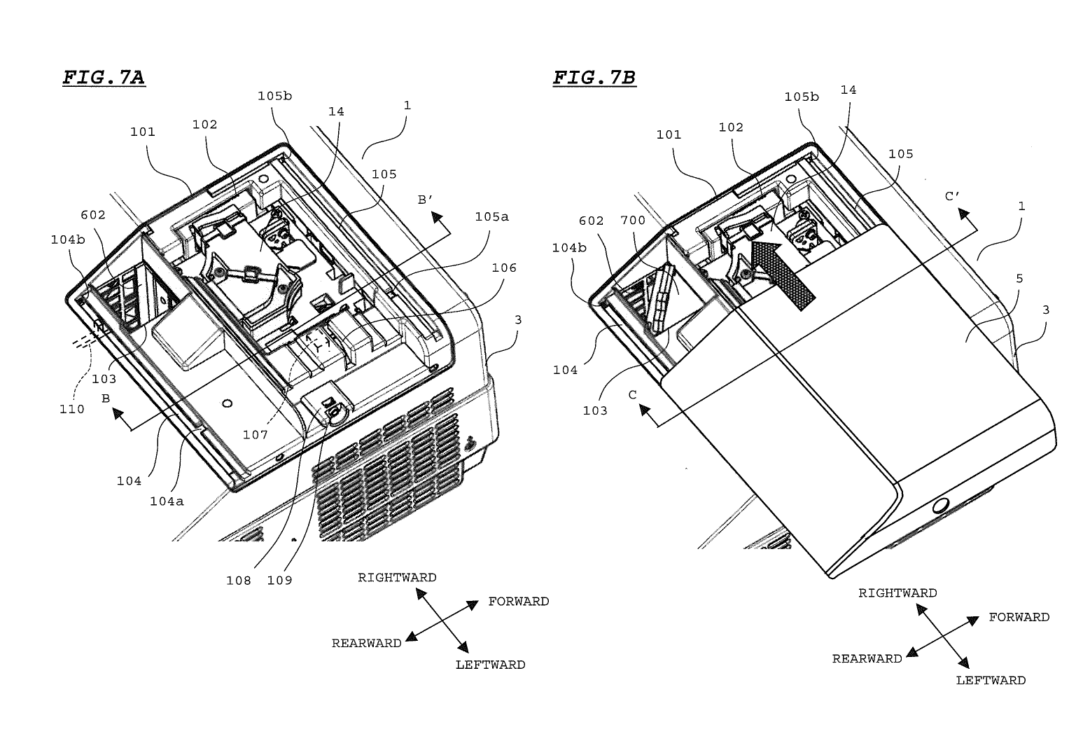

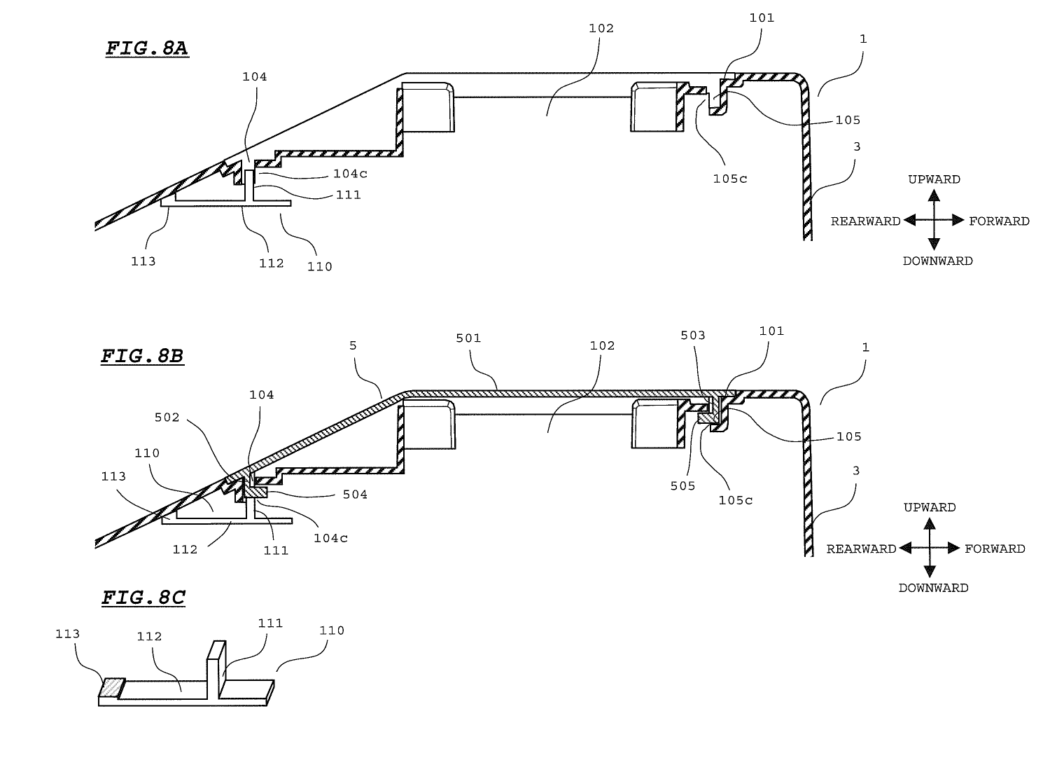

FIGS. 7A to 8C are diagrams showing a structure of attachment of the lamp cover 5 to the cover attachment part 101. FIG. 7A is a perpendicular view of major components of the projector in which the filter unit 700 is not yet housed in the filter housing part 602. FIG. 7B is a perpendicular view of major components of the projector in which the filter unit 700 is housed in the filter housing part 602 and the lamp cover 5 is partly closed. FIG. 8A is a cross-sectional view of FIG. 7A taken along line B-B′. FIG. 8B is a cross-sectional view of FIG. 7B taken along line C-C′. FIG. 8C is a perpendicular view of the cover stopper 110.

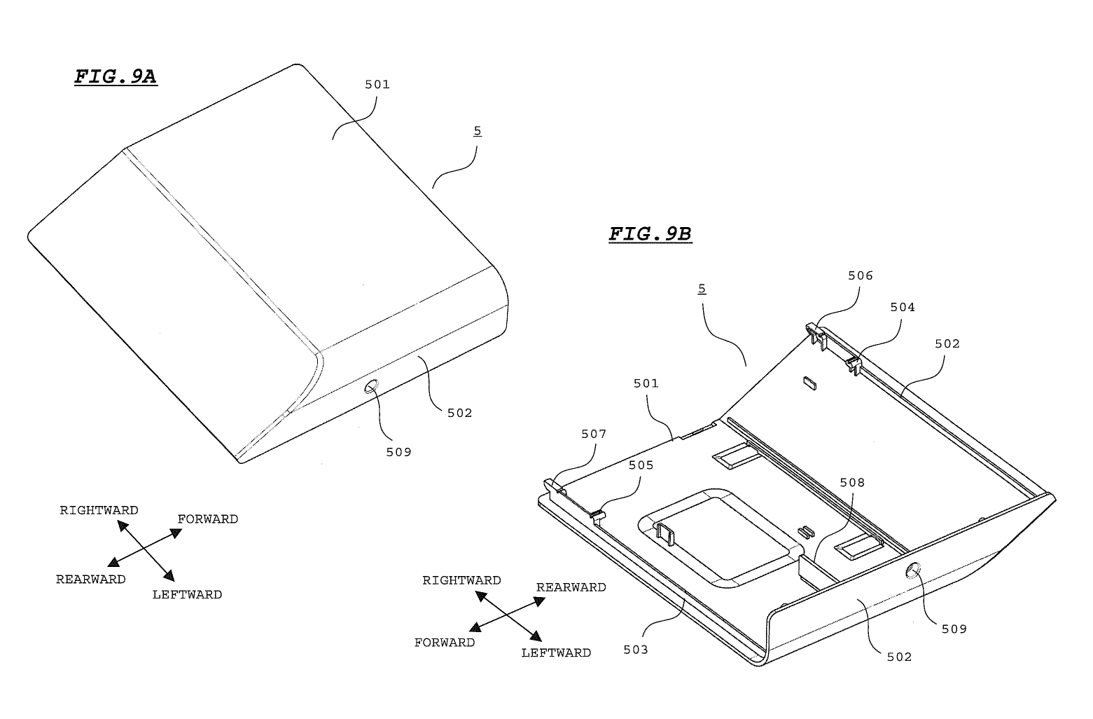

FIGS. 9A and 9B are diagrams showing a configuration of the lamp cover 5. FIG. 9A is a perpendicular view of the lamp cover 5 seen from the front side. FIG. 9B is a perpendicular view of the lamp cover 5 seen from the back side.

Referring to FIGS. 7A to 8C, the upper cabinet 3 has the cover attachment part 101 to which the lamp cover 5 is to be attached, ranging from a center part to a left side surface thereof. The cover attachment part 101 is slightly concaved than a surface of the upper cabinet 3. Accordingly, when the lamp cover 5 is slid along the upper surface of the upper cabinet 3 and attached to the cover attachment part 101, that is, when the lamp cover 5 is fully closed, the surface of the lamp cover 5 and the surface of the upper cabinet 3 become approximately flush with each other.

The cover attachment part 101 has a lamp opening 102. The lamp opening 102 is positioned immediately above the lamp unit 14 and is sized so as to allow the lamp unit 14 to be taken in and out. The lamp unit 14 is housed in the main body cabinet 1 through the lamp opening 102. In addition, the lamp unit 14 is taken out of the main body cabinet 1 through the lamp opening 102.

In addition, the cover attachment part 101 has a filter opening 103. The filter opening 103 is positioned immediately above the filter housing part 602 and has substantially the same size as that of the opening in the upper surface of the filter housing part 602. The filter unit 700 is housed in the filter housing part 602 through the filter opening 103. In addition, the filter unit 700 is taken out of the filter housing part 602 through the filter opening 103.

The cover attachment part 101 has guide grooves 104 and 105 extending in a right-left direction at a rear edge portion and a front edge portion thereof, respectively. As shown in FIG. 8A, the guide groove 104 has a rear wall and is open at front and bottom portions thereof. The guide groove 105 has front and bottom walls and is open at a rear portion thereof. The cover attachment part 101 has at the guide grooves 104 and 105 insertion openings 104a and 105a through which the shaft parts 504 and 505 of the lamp cover 5 pass from the above, respectively.

In addition, the cover attachment part 101 has a recess 106 made longer in a right-left direction on the left side of the lamp opening 102, as shown in FIG. 7A. The cover attachment part 101 has behind the recess 106 a detection switch 107 for detecting that the lamp cover 5 is fully closed. An actuator part of the detection switch 107 is exposed at a right end portion of the recess 106. The detection switch 107 uses a micro-switch, for example.

When the lamp cover 5 is fully closed and an operation rib 508 (refer to FIGS. 9A and 9B) provided on the back surface of the lamp cover 5 contacts the actuator part, the detection switch 107 is turned on. Accordingly, it is detected that the lamp cover 5 is fully closed.

The cover attachment part 101 has amounting portion 108 at a left end portion thereof. A nut 109 is embedded sideways into the mounting part 108.

As shown in FIGS. 8A to 8C, the upper cabinet 3 has on a back surface thereof a cover stopper 110 behind the filter opening 103 and under the guide groove 104.

The cover stopper 110 is constituted of a projection part 111 and a support part 112. The projection part 111 extends in an up-down direction and has a leading end portion jutting into the guide groove 104. The support part 112 is formed in a beam-like shape extending in a front-rear direction to support the projection part 111. The support part 112 has a base end portion connected to the back surface of the upper cabinet 3 by a connection part 113. The support part 112 is made thinner in an up-down direction and can be bent downward with the base end portion as a supporting point, to an extent that at least the leading end portion of the projection part 111 almost comes out of the guide groove 104. The upper cabinet 3 is made of a resin material, and the cover stopper 110 is integrated with the upper cabinet 3.

Alternatively, the cover stopper 110 may be separated from the upper cabinet 3 and be fixed with a screw or the like to the upper cabinet 3. Besides, the cover stopper 110 may be made of a resin material different from that of the upper cabinet 3 or a metal material.

As shown in FIGS. 9A and 9B, the lamp cover 5 is constituted of an upper plate 501 and a side plate 502. The upper plate 501 is inclined at a rear portion thereof to be adapted to the shape of the upper cabinet 3.

The upper plate 501 has guide ribs 502 and 503 extending in a right-left direction at rear and front end portions of a back surface thereof, respectively. The upper plate 501 has a shaft part 504 projecting forward on a left side of the right end portion of the guide rib 502. The upper plate 501 has an engagement part 506 projecting rightward at the right end portion of the guide rib 502. Similarly, the upper plate 501 has a shaft part 505 projecting rearward on a left side of a right end portion of the guide rib 503. The upper plate 501 has an engagement part 507 projecting rightward at the right end portion of the guide rib 503. When the lamp cover 5 is fully closed, the engagement parts 506 and 507 are engaged with the engagement holes 104b and 105b (FIG. 7A) formed in the cover attachment part 101.

The upper plate 501 further has on the back surface thereof the operation rib 508 housed in the recess 106 (FIG. 7A) of the cover attachment part 101. As described above, when the lamp cover 5 is fully closed, the operation rib 508 turns on the detection switch 107.

The side plate 502 has a mounting hole 509. When the lamp cover 5 is fully closed, the mounting hole 509 aligns with a screw hole of the nut 109 (FIG. 7A). Accordingly, when being screwed with the nut 109, the lamp cover 5 is fixed to the upper cabinet 3.

In this manner as described above, when the lamp cover 5 is attached to the cover attachment part 101, the guide ribs 502 and 503, the shaft parts 504 and 505, and the engagement parts 506 and 507, are inserted into the guide grooves 104 and 105 from above. At that time, a leading end portion of the shaft part 504 is inserted into an opening 104c at a front portion of the guide groove 104 through the insertion opening 104a, as shown in FIG. 8B. Similarly, a leading end portion of the shaft part 505 is inserted into an opening 105c at a rear portion of the guide groove 105 through the insertion opening 105a.

After that, the lamp cover 5 is slid rightward. The guide ribs 502 and 503, the shaft parts 504 and 505, and the engagement parts 506 and 507, are guided and moved rightward by the guide grooves 104 and 105. At that time, the shaft parts 504 and 505 are engaged with the openings 104c and 105c, thereby to restrict upward movement of the lamp cover 5.

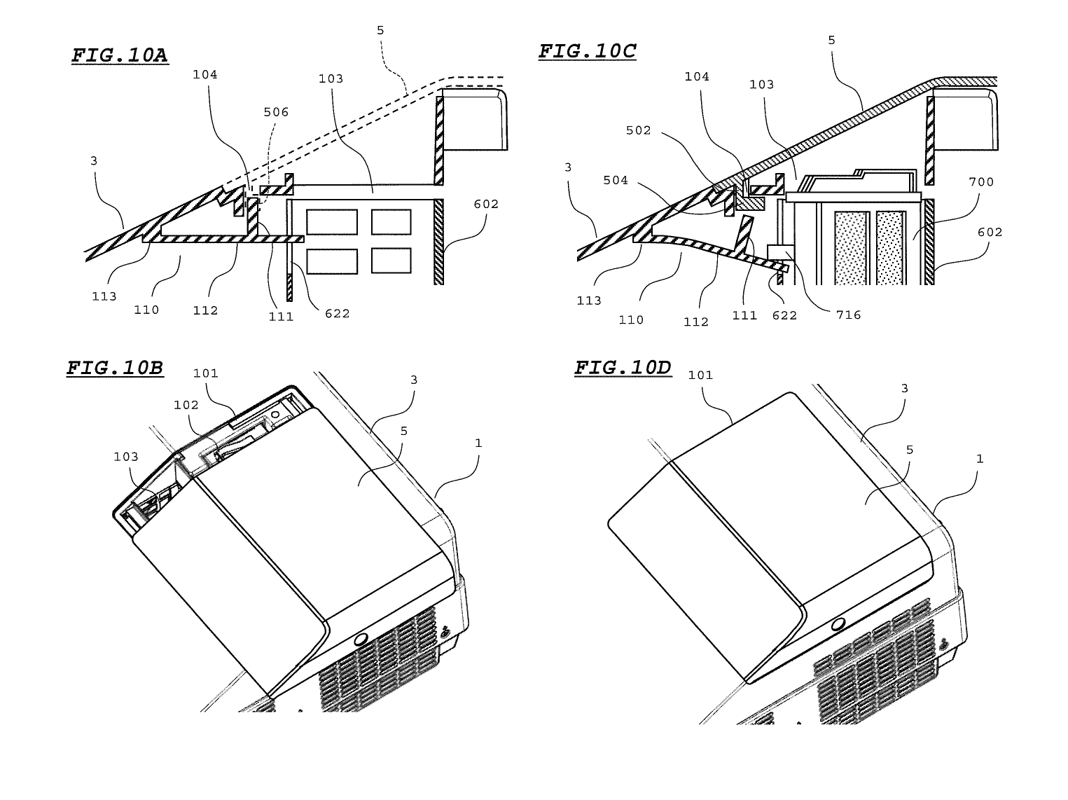

FIGS. 10A and 10B are diagrams showing that the lamp cover 5 is closed when the filter unit 700 is not housed in the filter housing part 602. FIGS. 10C and 10D are diagrams showing that the lamp cover 5 is closed after the filter unit 700 is housed in the filter housing part 602. FIGS. 10A and 10C are cross-sectional views of the filter opening 103 and a neighboring area thereof. FIGS. 10B and 10D are perpendicular views of major components of the cover attachment parts 101 and a neighboring area thereof. FIG. 10A shows by broken lines the lamp cover 5 which is actually positioned more in front than illustrated in the cross-sectional view.

When the filter unit 700 is not attached to the filter housing part 602, the projection part 111 of the cover stopper 110 is inserted into the guide groove 104. At that time, the projection part 111 is positioned in a path of movement of the engagement part 506 when the lamp cover 5 is being closed, that is, on a line contacting with the moving engagement part 506 when the lamp cover 5 is being closed.

Accordingly, when the user is closing the lamp cover 5 without attaching the filter unit 700 in the filter housing part 602, the engagement part 506 contacts the projection part 111 in the middle of closure of the lamp cover 5, as shown in FIG. 10A. As a result, the lamp cover 5 is not fully closed as shown in FIG. 10B, and the detection switch 107 does not detect the closure of the lamp cover 5. Therefore, even if the user performs an operation for starting the projector in this state, the projector does not start operation.

Meanwhile, when the filter unit 700 is attached in the filter housing part 602, the pressing piece 716 presses downward the leading end portion of the support part 112 positioned on the notch part 622, as shown in FIG. 10C. Accordingly, the support part 112 bends downward and the projection part 111 comes out of the guide groove 104. That is, the projection part 111 evacuates from the line contacting the engagement part 506.

Accordingly, when the user closes the lamp cover 5 after attaching the filter unit 700 in the filter housing part 602, the engagement part 506 does not contact the projection part 111. As a result, the lamp cover 5 is fully closed as shown in FIG. 10D, and the detection switch 107 detects the closure of the lamp cover 5. Therefore, when the user operates an operation for starting the projector, the projector starts operation.

As described above, this embodiment makes it possible to detect that the lamp cover 5 is closed while the filter unit 700 is housed in the filter housing part 602. This prevents that the projector starts operation with the filter unit 700 not attached and thus the lamp unit 14 is exposed to dust and the like. In addition, it is possible to prevent that the projector starts operation in a state where the lamp cover 5 remains unclosed and the user can put a hand into the main body cabinet 1 through the lamp opening 102 or the filter opening 103.

In addition, in this embodiment, when the lamp cover 5 is closed with the filter unit 700 housed in the filter housing part 602, the detection sensor 107 detects the closure of the lamp cover 5. Accordingly, the detection switch 107 can detect both the attachment of the filter unit 700 and the closure of the lamp cover 5.

Further, in this embodiment, the cover stopper 110 allows the projection part 111 to come into and out of the guide groove 104, using a bend in the support part 112 formed in a beam-like shape. In addition, the leading end portion of the support part 112 is positioned in the vicinity of the filter housing part 602, and the support part 112 is pressed and bent by the pressing piece 716 on the filter unit 700. Further, the engagement part 507 guided by the guide groove 104 is used as a contact part provided on the lamp cover 5. Accordingly, it is possible to realize readily a configuration for detecting both the attachment of the filter unit 700 and the closure of the lamp cover 5 by the one detection switch 107.

In addition, in this embodiment, since the support part 112 is formed in a beam-like shape, the support part 112 is elastically bent without the need to use another member such as a spring, thereby achieving a simplified configuration.

Moreover, in this embodiment, the upper cabinet 3 has the filter opening 103 in the upper surface thereof. The lamp cover 5 slides over the upper surface. The guide groove 104 is formed in the upper surface so as to extend in a direction in which the lamp cover 5 slides. In addition, when the lamp cover 5 slides, the engagement part 506 is inserted into the guide groove 104 and guided by the guide groove 104. At that time, the projection part 111 juts into the guide groove 104 and contacts the engagement part 506. Accordingly, the engagement part 506 for guiding the sliding lamp cover 5 can be used as a contact part to contact the projection part 111, thereby resulting in a simplified configuration.

### MODIFICATION EXAMPLE

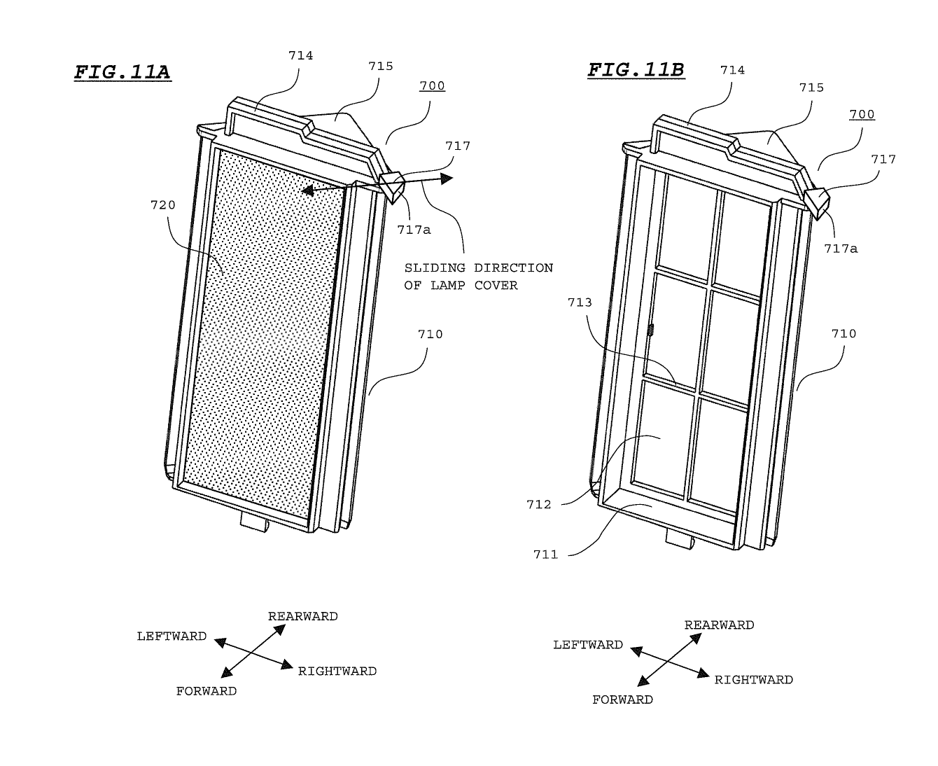

A projector according to a modification example will be described below with reference to FIGS. 11A to 14D. In the modification example, identical components to those in the foregoing embodiment are given reference numerals identical to those in the foregoing embodiment, and thus descriptions thereof are omitted here.

FIGS. 11A and 11B are diagrams showing a configuration of the filter unit 700 in the modification example. FIG. 11A is a perpendicular view of the filter unit 700 with the filter 720 attached. FIG. 11B is a perpendicular view of the filter unit 700 with the filter 720 not yet attached.

The filter unit 700 in this modification example is provided with a guide piece 717, in place of the pressing piece 716, at a right end portion of the upper surface thereof. The guide piece 717 has a guide surface 717a at a leading end hereof. As shown in FIG. 11A, the guide surface 717a is inclined with respect to the sliding direction of the lamp cover 5. In this modification example, since the filter unit 700 does not have the pressing piece 716, the filter housing part 602 has a notch part 622.

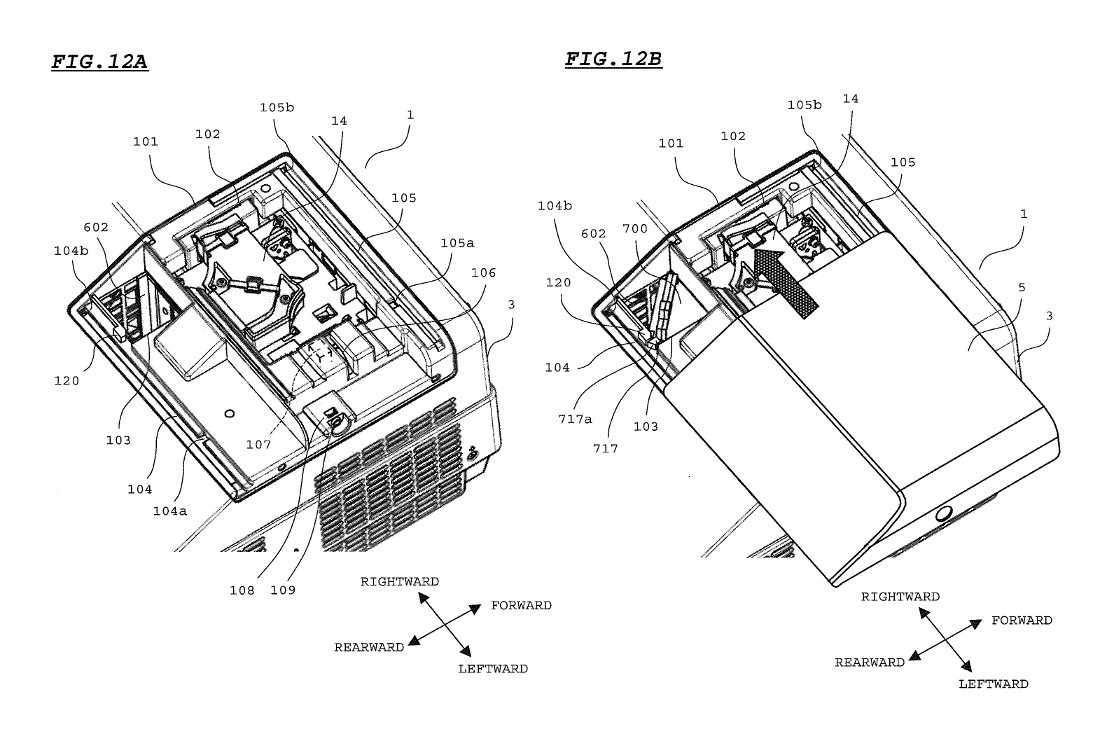

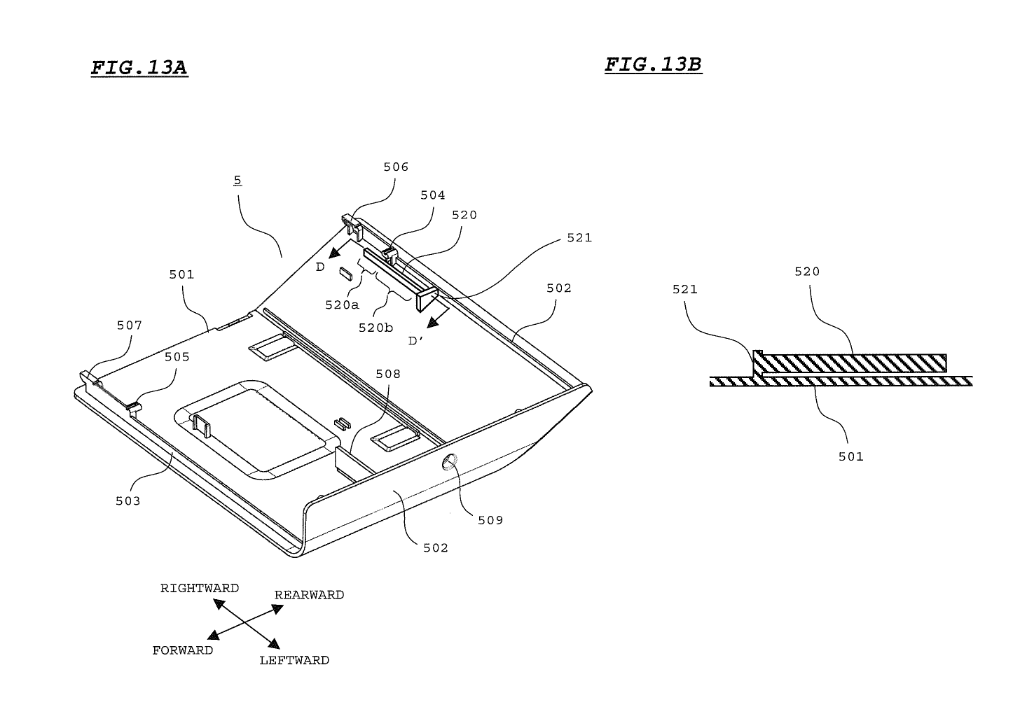

FIGS. 12A and 12B are diagrams showing a structure of attachment of the lamp cover 5 to the cover attachment part 101 in the modification example. FIG. 12A is a perpendicular view of major components of the projector in which the filter unit 700 is not yet housed in the filter housing part 602. FIG. 12B is a perpendicular view of major components of the projector in which the filter unit 700 is housed in the filter housing part 602 and the lamp cover 5 is partly closed. FIGS. 13A and 13B are diagrams showing a configuration of the lamp cover 5. FIG. 13A is a perpendicular view of the lamp cover 5 seen from the back side. FIG. 13B is a cross-sectional view of FIG. 13A taken along line D-D′.

As shown in FIG. 12A, the upper cabinet 3 in this modification example has a projection part 120 at a rear end portion of the filter opening 103, in place of the cover stopper 110. When the filter 700 is housed in the filter housing part 602, the guide surface 717a of the guide piece 717 is positioned on a left side of the projection part 120, that is, in front of the projection part 120 in a direction in which the lamp cover 5 is closed, as shown in FIG. 12B.

As shown in FIGS. 13A and 13B, the lamp cover 5 in this modification example has a contact bar 520 on a back surface thereof. The contact bar 520 is formed in a beam-like shape and has a base end portion connected to the upper plate 501 by a connection part 521. A leading end portion of the contact bar 520 serves as a contact part 520a contacting the projection part 120. An area of the contact bar 520 ranging from middle to base end portions serves as a support part 520b supporting the contact part 520a. The contact bar 520 is made thinner in a front-rear direction, and the support part 520b can be bent rearward (in a direction toward the guide rib 502). The lamp cover 5 is made of a resin material, and the contact bar 520 is integrated with the lamp cover 5. The contact bar 520 is arranged at a position where the contact part 520a contacts the projection part 120 when the lamp cover 5 is closed.

The contact bar 520 may be separated from the lamp cover 5 and fixed with a screw or the like to the lamp cover 5. In addition, the contact bar 520 may be made of a resin material different from that for the lamp cover 5 or a metal material. Further, although the contact part 520a of the contact bar 520 is formed in the same shape as that of the support part 520b, the contact part 520a may be formed in a larger size than that of the support part 520b.

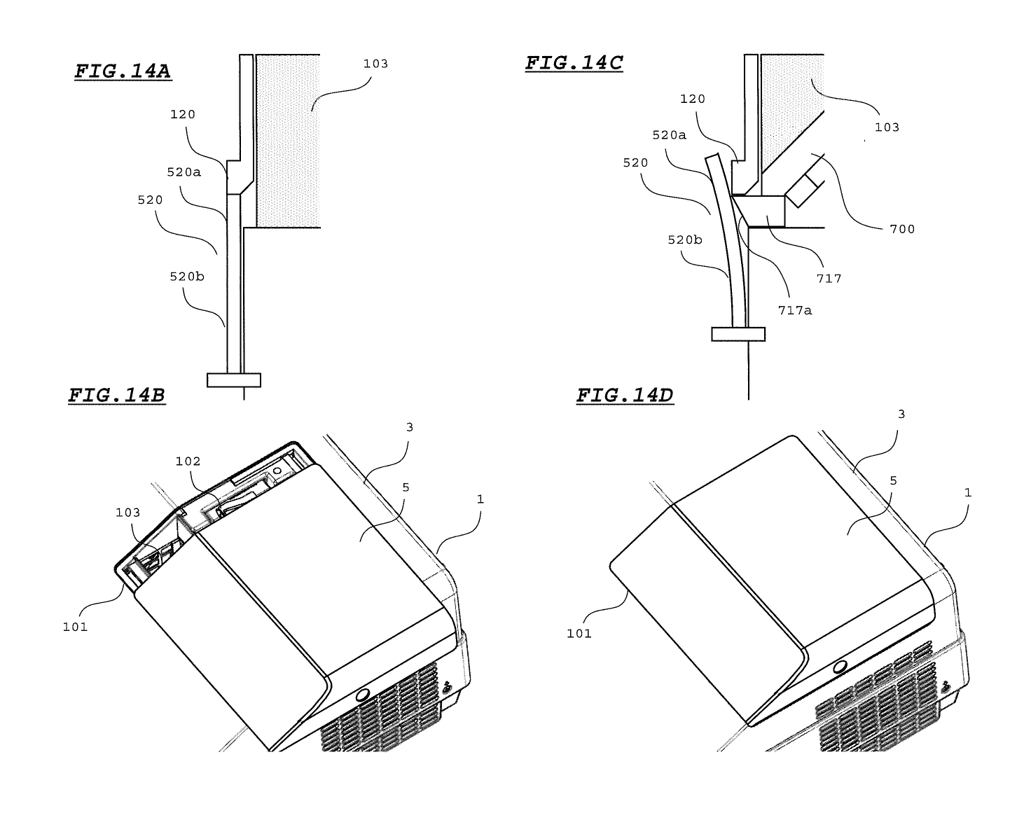

FIGS. 14A and 14B are diagrams showing that the lamp cover 5 is closed with the filter unit 700 not housed in the filter housing part 602, in the modification example. FIGS. 14C and 14D are diagrams showing that the lamp cover 5 is closed after the filter unit 700 is housed in the filter housing part 602, in the modification example. FIG. 14A is a schematic plan view of major components of the contact bar 520 in a state where the lamp cover 5 is closed with the filter unit 700 not housed in the filter housing part 602. FIG. 14C is a schematic plan view of major components of the contact bar 520 in a state where the lamp cover 5 is closed after the filter unit 700 is housed in the filter housing part 602. FIGS. 14B and 14D are perpendicular views of major components of the cover attachment part 101 and a neighboring area thereof.

If the user closes the lamp cover 5 without attaching the filter unit 700 in the filter housing part 602, the contact part 520a of the contact bar 520 remains on the line contacting the projection part 120 and moves toward the projection part 120, and then contacts the projection part 120 as shown in FIG. 14A. Accordingly, the lamp cover 5 is not fully closed as shown in FIG. 14B, and the detection switch 107 does not detect closure of the lamp cover 5. Therefore, even if the user performs an operation for starting the projector in this state, the projector does not start operation.

On the other hand, when the user attaches the filter unit 700 in the filter housing part 602, the guide surface 717a of the guide piece 717 is positioned in front of the projection part 120. If the lamp cover 5 is closed in this state, the contact part 520a of the contact bar 520 contacts the guide surface 717a before contacting the projection part 120, as shown in FIG. 14C. Then, the support part 520b is bent in a direction of separating from the filter opening 103, and the contact part 520a comes out of the line contacting the projection part 120 and passes by the projection part 120 along the guide surface 717a. Accordingly, the lamp cover 5 is fully closed as shown in FIG. 14D, and the detection switch 107 detects the closure of the lamp cover 5. Therefore, when the user performs an operation for starting the projector in this state, the projector starts operation.

As in the foregoing, this modification example makes it possible to prevent that the projector starts operation when the filter unit 700 is not attached in the filter housing part 602 and the lamp cover 5 is not fully closed, as in the foregoing embodiment. Further, it is possible to detect both the attachment of the filter unit 700 and the closure of the lamp cover 5 by the one detection switch 107.

Moreover, in this modification example, the projection part 120 is arranged in the vicinity of the filter opening 103, and the filter unit 700 is housed in the filter housing part 602. Accordingly, the guide piece 717 extends from the filter unit 700 toward the projection part 120, and the guide surface 717a of the guide piece 717 is positioned in front of the projection part 120. In addition, the contact bar 520 displaces the contact part 520a using a bent in the support part 520b formed in a beam-like shape. This makes it possible to realize readily a configuration for detecting both the attachment of the filter unit 700 and the closure of the lamp cover 5 by the one detection switch 107.

In this modification example, since the support part 520b is formed in a beam-like shape, the support part 112 is elastically bent without the need to use another member, thereby resulting in a simplified configuration.

### Others

The present invention is not limited to the foregoing embodiment and modification example, but can be modified as appropriate in various manners within the scope of technical ideas recited in the claims.

For instance, in the foregoing embodiment and modification example, the filter unit 700 is exemplified as a part to be attached in the present invention. However, a part to be attached in the present invention is not limited to the filter unit 700 but may be the lamp unit 14, for example. In this case, the upper cabinet 3 has the cover stopper 110 on the back surface thereof so that the projection part 111 can be inserted into the guide groove 105 near the lamp opening 102, for example. In addition, the lamp unit 14 is provided with a pressing piece. Then, when the lamp unit 14 is attached in the main body cabinet 1, the pressing piece presses the support part 112 and the projection part 111 evacuates from the guide grove 105. Accordingly, when the lamp unit 14 is attached in the main body cabinet 1, the lamp cover 5 is fully closed.

In addition, if the imager unit 15 is configured to include the prism unit, the upper cabinet 3 may have on the upper surface thereof a prism opening for replacement of the prism unit, such that the prism opening is closed by a prism cover. In this case, the present invention may be applied to allow closure of the prism cover to be detected after attachment of the prism unit in the main body cabinet 1. In this arrangement, the prism unit serves a part to be attached in the present invention.

Further, in the foregoing embodiment, the projection part 111 is displaced by bending the support part 112 formed in a beam-like shape. However, the projection part 111 may be displaced, not by bending the support part 112 but using a separately provided spring or the like. Similarly, with regard to the contact bar 520 in the foregoing modification example, the contact part 520a may be displaced not by bending the support part 520b but using a separately provided spring or the like.

Moreover, in the foregoing embodiment, the filter opening 103 and the lamp opening 102 are formed in the upper surface of the main body cabinet 1, but the position of these openings are not limited to this. For example, the filter opening 103 and the lamp opening 102 may be formed in the right and left side surfaces, rear surface, or bottom surface of the main body cabinet 1, for example.

Besides, the embodiment of the invention may be changed or modified in various ways as necessary, within the scope of technical ideas in the claims.

What is claimed is:

1. A projection display device, comprising:
an opening formed in a main body cabinet;
a part to be attached in the main body cabinet through the opening;
a cover which covers the opening;
a detector which detects closure of the cover; and
a first contact part and a second contact part which contact each other when the cover is being closed, thereby to prevent the cover from being closed up to a position where the closure is detected by the detector, wherein
the first contact part is positioned on a line contacting the second contact part at closure of the cover and is capable of evacuating to a position out of the line when the part to be attached is not attached in the main body cabinet, and
the projection display device further includes an evacuation part to evacuate the first contact part to the position out of the line when the part to be attached is attached in the main body cabinet.

2. The projection display device according to claim 1, wherein
the first contact part is provided on the main body cabinet, and the second contact part is provided on the cover,
the first contact part is supported by a support part capable of displacing in a direction in which the first contact part comes out of the line, and
the evacuation part includes a pressing part which presses the support part when the part to be attached is attached to the main body cabinet, thereby to evacuate the first contact part to a position out of the line.

3. The projection display device according to claim 2, wherein
the support part is formed in a beam-like shape and one end portion of the support part is fixed to the main body cabinet, and
when the other end of the support part is pressed by the pressing part, the support part is bent with the one end portion as a supporting point, and the first contact part comes out of the line.

4. The projection display device according to claim 2, wherein
the cover is capable of sliding over one side surface of the main body cabinet in which the opening is formed,
the side surface has a groove part extending in a direction in which the cover slides,
the second contact part includes a guide part which is inserted into the groove part and is guided through the groove part when the cover slides, and
the first contact part juts into the groove part and contacts the guide part.

5. The projection display device according to claim 1, wherein
the first contact part is provided on the cover, and the second contact part is provided on the main body cabinet,
the first contact part is supported by a support part capable of displacing in a direction in which the first contact part comes out of the line, and
the evacuation part includes a guide surface which evacuates the first contact part moving toward the second contact part at closure of the cover, to a position out of the line.

6. The projection display device according to claim 5, wherein
the support part is formed in a beam-like shape and one end portion of the support part is fixed to the cover, and
when the first contact part moves along the guide surface, the support part is bent with the one end portion as a supporting point and the first contact part comes out of the line.
